(19) United States
(12) Patent Application Publication
(10) Pub. No.: US 2002/0080012 A1
(43) Pub. Date: Jun. 27, 2002

(54) Safety armband

(76) Inventor: Nigel Broderick, Saltash (GB)

Correspondence Address: Ira S. Dorman, Suite 200, 330 Roberts Street, East Hartford, CT, 06108, US

(21) Appl. No.: 10/021,674

(22) Filed: Dec. 12, 2001

(30) Foreign Application Priority Data
Dec. 23, 2000 (GB) 00 31 630.7

(51) Int. Cl. G08B 5/00

(52) U.S. Cl. 340/332; 340/331

(57) ABSTRACT

Two flexible waterproof plastic strips sealed around three edges form a pocket containing a self-coiling metal strip which grips around the arm of the wearer. The pocket also contains a series of high-intensity LEDs interposed between the metal strip and one of the flexible strips 1, which is reflective but allows light from the LEDs to pass through rendering the wearer more visible at night. The LEDs are powered by cells contained in a two-part housing 9 which also contains a microchip to supply pulsed power to the LEDs so that they are caused to flash at about one per second.

### TECHNICAL FIELD OF THE INVENTION

This invention relates to a safety armband.

### BACKGROUND

The present invention seeks to provide a new and inventive form of safety armband which is suitable for use under conditions of low ambient light.

### SUMMARY OF THE INVENTION

The invention proposes a safety armband for use in low light conditions, which includes inner and outer strips sealed together along their edges to form an elongate pocket, a self-coiling metal strip located in the pocket between the flexible strips tending to cause the armband to adopt a curled configuration to grip the arm of a wearer, and at least one light source which is carried by the strips to increase the visibility of the wearer.

The self-coiling strip preferably adopts a curved transverse shape when straightened out whereby the metal strip tends to remain in a straight configuration.

In a preferred form of the armband there is a rigid housing secured at one end of the flexible strips. The housing may contain one or more electrical cells which supply power to the light sources through a pair of flexible conductors which travel along the pocket between the strips.

In a preferred form of the invention the housing may contain an electronic flasher unit arranged to supply pulsed power to the conductors so that the light sources flash. This may increase visibility whilst at the same time reducing power consumption.

The housing may also include an on/off switch. Further, the housing preferably includes a cover which provides access to a battery compartment within the housing so that the electrical cells can be changed when necessary.

The light sources may be light emitting diodes (LEDs).

The two strips are preferably formed of moisture-impermeable plastics material. The exposed edges of the flexible strips are preferably joined by a continuous seal to prevent moisture ingress.

The outer strip is preferably formed of a light-reflective plastics material.

### BRIEF DESCRIPTION OF THE DRAWINGS

The following description and the accompanying drawings referred to therein are included by way of non-limiting example in order to illustrate how the invention may be put into practice. In the drawings:

FIG. 1 is a front view of a safety armband in accordance with the invention shown in a straightened-out configuration;

FIG. 2 is an enlarged detail of one end of the armband viewed from the opposite rear side;

FIG. 3 is an edge view of the armband shown in a coiled configuration; and

FIG. 4 is an enlarged detail of the lower end of the armband as viewed in FIG. 1, shown partially cut-away, and including an inset sectional detail A.

### DETAILED DESCRIPTION OF THE DRAWINGS

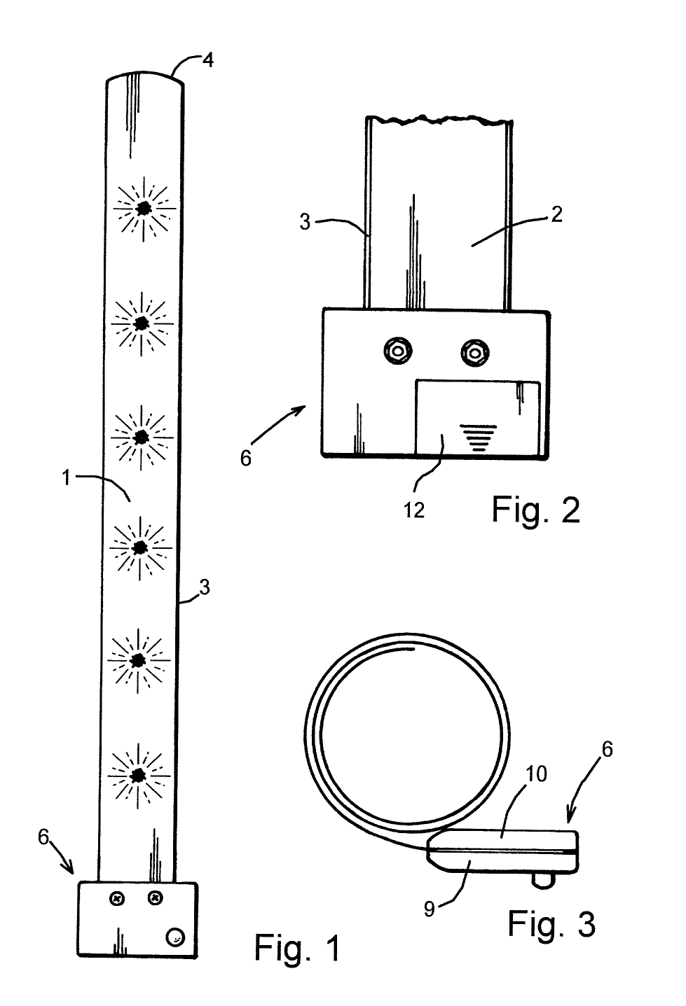

Considering FIGS. 1 to 3 together, the safety armband has two superimposed elongate outer and inner strips 1 and 2 of moisture-impermeable flexible plastics sheet such as pvc. The outer strip 1 is formed of a yellow light-transmissive material having a smooth front surface, its rear surface being textured to form a multiplicity of miniature lenses which render the material highly reflective. The inner strip 2 need not be light-transmissive or reflective and could simply be an opaque pvc strip. The two strips 1 and 2 are joined along their opposed longitudinal edges by a continuous heat seal 3 which also extends around one end 4 of the superimposed strips so that the two strips form an elongate pocket which is open at one end. The open end is inserted into a two-part moulded plastics housing 6 of a generally planar-rectangular configuration.

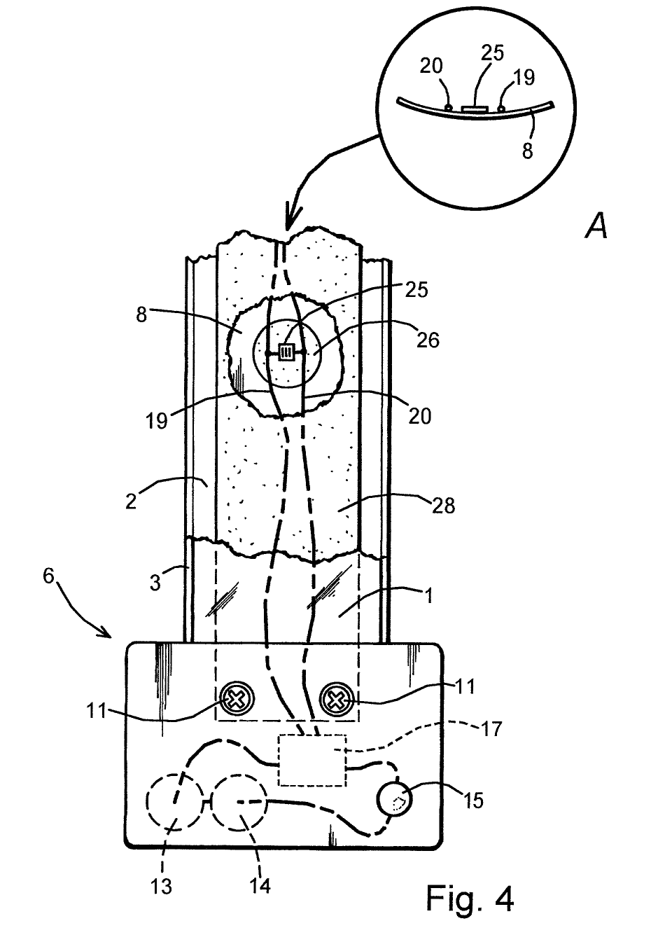

Referring to FIG. 4, the pocket formed by the two strips 1 and 2 contains an elongate self-coiling metal strip 8. The self-coiling nature of the strip 8 causes the armband to adopt the curled configuration shown in FIG. 3 to grip the arm of a wearer with the outer strip 1 facing outwards. When the strip 8 is coiled it has a straight transverse cross-section, but when the strip is straightened out it becomes arcuate in transverse cross-section as shown in the inset detail A, which thus retains the armband in a straight configuration until bent, in the manner of a steel measuring tape.

Continuing the description of FIG. 4, the housing 6 has front and rear sections 9 and 10 (FIG. 3) which may be snap-engaged and/or connected by one or more screws 11, rivets etc. which are inserted through the metal strip 8 to ensure a positive connection between the strip and the housing. A removable cover 12 (FIG. 2) in the rear section 10 provides access to an internal battery compartment which contains a pair of miniature cells 13 and 14. The cells are connected in series via an on/off push switch 15 which projects through the front housing section 9, allowing the switch to be operated while the armband is coiled around the arm. The cells supply an electronic flasher microchip 17 which produces a pulsed output voltage on a pair of insulated flexible electrical conductors 19 and 20 which travel along the pocket formed by the two strips 1 and 2.

The insulated conductors 19 and 20 travel along the front surface of the metal strip 6. At spaced intervals along the armband miniature high intensity red LEDs 25 (six in this example) are connected between the conductors 19 and 20 such that, when they are illuminated, the LEDs are visible through the outer strip 1, as indicated in FIG. 1. Each LED is separated from the metal strip 6 by an insulating patch 26. Thus, the LEDs flash at a rate of approximately one flash per second, determined by the pulsed output of the chip 17. The LEDs 25 and conductors 19 and 20 are covered by a thin light-transmitting layer 28 which is adhesively bonded to the strip 6 to hold the wires and LEDs in place.

Because of its self-curling nature the armband is very easy to apply under low light conditions, or even complete darkness, and there are no catches or buckles to connect. The reflective outer surface of the armband combined with the flashing LEDs ensures that the wearer has good visibility. Since the LEDs only operate in a pulsed manner the power consumption of the armband is low giving a long operating life before the cells 13 and 14 need replacing. The armband can be worn in the rain since it is sealed to prevent moisture reaching the electrical components.

It will be appreciated that the features disclosed herein may be present in any feasible combination. Whilst the above description lays emphasis on those areas which, in combination, are believed to be new, protection is claimed for any inventive combination of the features disclosed herein.

I claim:

1. A safety armband for use in low light conditions, which includes inner and outer strips sealed together along their edges to form an elongate pocket, a self-coiling metal strip located in the pocket between the flexible strips tending to cause the armband to adopt a curled configuration to grip the arm of a wearer, and at least one light source which is carried by the strips to increase the visibility of the wearer.

2. A safety armband according to claim 1, which has a plurality of light sources mounted in spaced positions along the strips.

3. A safety armband according to claim 1, in which the self-coiling strip adopts a curved transverse cross-sectional shape when straightened out whereby the metal strip tends to remain in a straight configuration.

4. A safety armband according to claim 1, in which there is a rigid housing secured at one end of the strips.

5. A safety armband according to claim 4, in which the housing is formed in two or more parts which are secured together with the strips inserted therebetween.

6. A safety armband according to claim 4, in which the housing contains at least one electrical cell to supply power to the light sources.

7. A safety armband according to claim 6, in which the housing includes a cover which is removable to provide access to a battery compartment containing said at least one electrical cell.

8. A safety armband according to claim 4, in which the housing contains an electronic flasher device arranged to supply pulsed power to the light sources causing them to flash.

9 A safety armband according to claim 4, in which the housing includes a switch for controlling the supply of electrical power to the light sources.

10. A safety armband according to claim 1, in which the light sources are connected to a pair of flexible conductors which travel along the strips.

11. A safety armband according to claim 10, in which the flexible conductors are contained within the pocket formed by the flexible strips.

12. A safety armband according to claim 1, in which the two flexible strips which form the elongate pocket are formed of moisture-impermeable plastics material.

13. A safety armband according to claim 12, in which the exposed edges of the opposed strips are joined by a continuous seal.

14. A safety armband according to claim 1, in which the outer strip consists of or includes a light-reflective plastics material.

15. A safety armband according to claim 1, in which the outer strip has a smooth outer surface with a multiplicity of lenses formed on its rear surface.

16. A safety armband according to claim 1, in which the light sources are interposed between the outer strip and the metal strip and the outer strip is light-transmissive.

17. A safety armband according to claim 1, in which the light sources consist of or include light emitting diodes.
